(19) United States
(12) Patent Application Publication
(10) Pub. No.: US 2007/0100908 A1
(43) Pub. Date: May 3, 2007

(54) Method and apparatus for tracking history information of a group session

(76) Inventors: Neeraj Jain, Rawatbhata (IN); Guy G. Romano, Elmhurst, IL (US)

Correspondence Address: MOTOROLA, INC., 1303 EAST ALGONQUIN ROAD, IL01/3RD, SCHAUMBURG, IL, 60196, US

(21) Appl. No.: 11/264,460

(22) Filed: Nov. 1, 2005

(51) Int. Cl. G06F 17/30

(52) U.S. Cl. 707/204

(57) ABSTRACT

A method and apparatus that facilitates tracking the history of a group session. According to one embodiment of the invention, responsive to a group session being initiated, a group session history record associated with the group session having at least two users is obtained (504). History information of the group session is then accordingly tracked (512, 518) to provide tracked history information, which is saved (530, 534) to the group session history record that can subsequently provide the tracked history information responsive to a user request.

### TECHNICAL FIELD

This invention relates generally to methods and apparatus for tracking history information of a group session.

### BACKGROUND

With the many advances in communications today, users are receiving more calls from various sources, such as interconnect calls, push-to-talk calls, cell phone calls, instant messages, and Internet conferences. These numerous means of communications offer great flexibility in connecting people, but may be overwhelming at times for users. For example, since it is becoming more common for users to share file objects or stream data on a call, multiple activities are now done using a cell phone than ever before. Moreover, because group sessions are also possible through multiple communications means, such as multicast or Internet conference, users of the group sessions are able to jump in-and-out of an ongoing group session. Notwithstanding this wide array of communications tools and flexibility available to the users, the only information that is currently typically being tracked is the recent call lists, and even this information typically does not include any detailed information relating to the call, such the file shared and/or the participation status of the users of the call.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 comprises a wireless communications system suitable for various embodiments of the invention;

FIG. 2 comprises an overview of a mobile station according to various embodiments of the invention;

FIG. 3 comprises an exemplary user interface providing a list of data files according to one embodiment of the invention;

FIG. 4 comprises an exemplary user interface providing a list of group sessions according to one embodiment of the invention;

FIG. 5 comprises a flow chart diagram of a tracking process triggered by a group session being initiated according to one embodiment of the invention;

FIG. 6 comprises a flow chart diagram of a process to provide the file session history records requested by a user according to one embodiment of the invention; and

FIG. 7 comprises a flow chart diagram of a process to provide the group session history records requested by a user according to one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, responsive to a group session being initiated, a group session history record associated with the group session having at least two users is obtained. History information of the group session is then accordingly tracked to provide tracked history information, which is saved to the group session history record in order to subsequently provide the tracked history information responsive to a user request. According to one embodiment, to obtain the group session history record, it is either created or retrieved based upon whether the group session is not based or based on a previous group session.

In an embodiment, to track the history information of the group session, the group session history record is linked with one or more previously saved group session history records when at least one of the two users in the group session is invited based on this previously saved group session. For one specific embodiment, to track the history information of the group session, a session participation record is generated for tracking current participation status of these users. The session participation record is continuously updated using the current participation status and associated with the group session history record. According to an embodiment, the current participation status may include a participant user status indicating participation in the group session and nonparticipant user status indicating nonparticipation in the group session.

According to one embodiment of the tracking of the group session history information, a file session history record associated with one more shared data files shared during the group session is obtained and updated with the tracked history information of the group session history record. The file session history record is saved in order to subsequently provide the tracked history information responsive to a user request. In a particular embodiment, to obtain the file session history record, the file session history record is created if the shared data file has not been previously shared during a group session and/or retrieved when the shared data file has been previously shared during a group session. The file session history record is also linked with one or more previously saved file session history records when at least one of the two users is invited based on the previously saved file session history record, according to one embodiment. The shared data file is further associated with the group session history record.

According to various embodiments, a list of items based, at least in part, on history information related to group sessions is provided responsive to a user request to obtain the list of items, followed by one or more saved session history records associated with one or more selected items. Specifically, in one embodiment, the session history record may either be a group session history record and/or a file session history record, and the list of items may be group sessions and/or shared data files of the group sessions. Setup of a group session may then be initiated based, at least in part, on these previously saved records and/or selected items.

For one embodiment, responsive to a user input to initiate a group session, a group list having one or more users that is based, at least in part, on the previously saved session history record associated with the selected item, may be used to initiate setup of the group session. In an embodiment, a call type and/or service type that is based, at least in part, on user input, the group list, and a previously saved history record associated with the selected item is assessed. Using the call type and/or service type, setup of the group session is initiated, according to one embodiment.

According to various embodiments, an apparatus is also provided that includes a group session manager circuit to obtain, responsive to a group session being initiated, a group session history record associated with a group session having at least two users, a history tracker circuit coupled to the group session manager circuit to track history information of the group session to provide tracked history information saved to the group session history record, and a memory circuit to store the group session history record for subsequent user usage. Specifically, in one embodiment, the group session manager circuit obtains a file session history record associated with a shared data file during the group session and updates the file session history record with the tracked history information of the group session history record, and the memory circuit saves the file session history record for subsequent user usage. For an embodiment, a user interface coupled to the group session manager and the memory circuit is included such that the user interface provides a list of items based, at least in part, on history information related to group sessions responsive to a user request to obtain the list of items and at least one previously saved session history record associated with a selected item.

Through these various teachings, a mechanism that, among other things, tracks history information of a group session that can subsequently be provided responsive to a user request is provided. Specifically, the various teachings enable users to establish a new group session based on session history information associated with previous group sessions, which may include a group list based on the user participation status, call type, and/or service type. Moreover, according to various embodiments, a new group session can also be initiated based on a shared data file shared during a previous group session. Since history information of a group session is being tracked, users are able to refer to these saved tracked history information to initiate other new group sessions. Thus, a more flexible and desired user functionality has been added to the communications system.

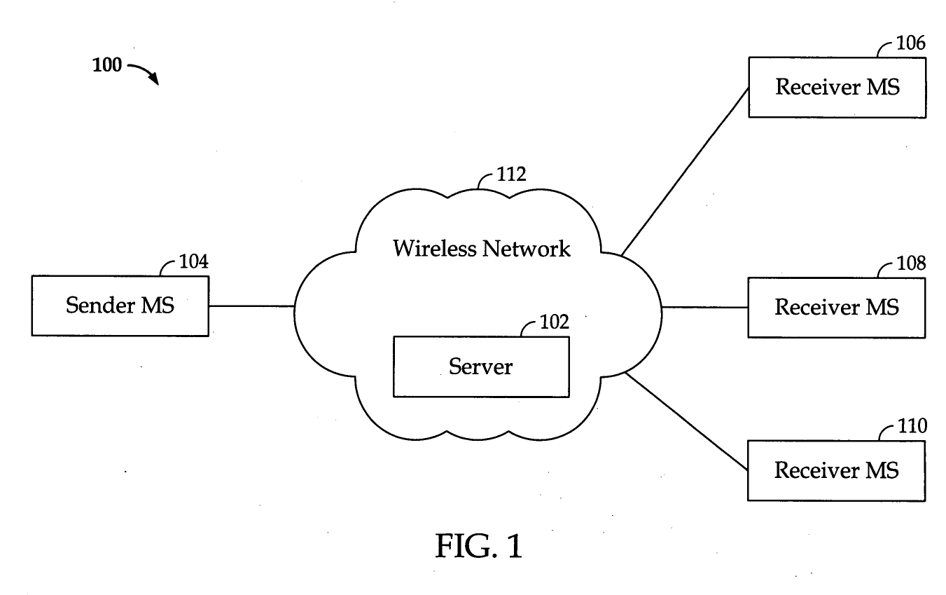

Referring now to the drawings, and in particular to FIG. 1, for purposes of providing an illustrative but non-exhaustive example to facilitate this description, a specific operational paradigm using a wireless communication system is shown and indicated generally at 100. Those skilled in the art, however, will recognize and appreciate that the specifics of this illustrative example are not specifics of the invention itself and that the teachings set forth herein are applicable in a variety of alternative settings. For example, since the teachings described are not platform dependent, they can be applied to various systems, such as, but not limited to, Public Switched Telephone Networks (PSTNs), Code Division Multiple Access (CDMA) systems, Time Division Multiple Access (TDMA) systems, Universal Mobile Telecommunications Systems (UMTSs), Integrated Digital Enhanced Network (iDEN) systems, and General Packet Radio Service (GPRS) systems. In fact, any communication network that includes the feature of a group session is contemplated and is within the scope of the invention. It will be understood that a group session includes any call with at least two users, such as a cell phone call between two users and/or a conference with three or more users. Moreover, the group session as described includes any means of communication, including but not limited to interconnect calls, push-to-talk calls, cell phone calls, Internet phone calls, instant messages, multicast stream data, and like.

Referring now to the exemplary wireless communication system 100 shown in FIG. 1, a server 102 is included for exchanging communications between multiple sender mobile stations (“MSs”) (one shown) 104 and receiver MSs (three shown) 106, 108, 110 via a wireless network 112. For example, in one embodiment, when the sender MS 104 initiates a group session with one receiver MS or multiple receiver MSs, the group session is generally sent to the server 102 for processing. The server 102, thus, includes any devices or components that service the group session between the sender MS and the receiver MSs. For example, in the context of a cellular communication system, the server 102 would include the base stations, foreign agents, radio network controller, radio access network, Internet Protocol based servers, and so forth. As shown, numerous different implementations are possible through the various teachings provided, and other implementations using all or part of any component in the system, even if not specifically shown, are contemplated and thus are within the scope of the invention. Moreover, because current cell phones have many similar functions to that of computer devices, a mobile station will be herein used to refer to any device that can transmit data, which includes, but is not limited to, land-line telephones, cell phones, personal digital assistants, and/or computers.

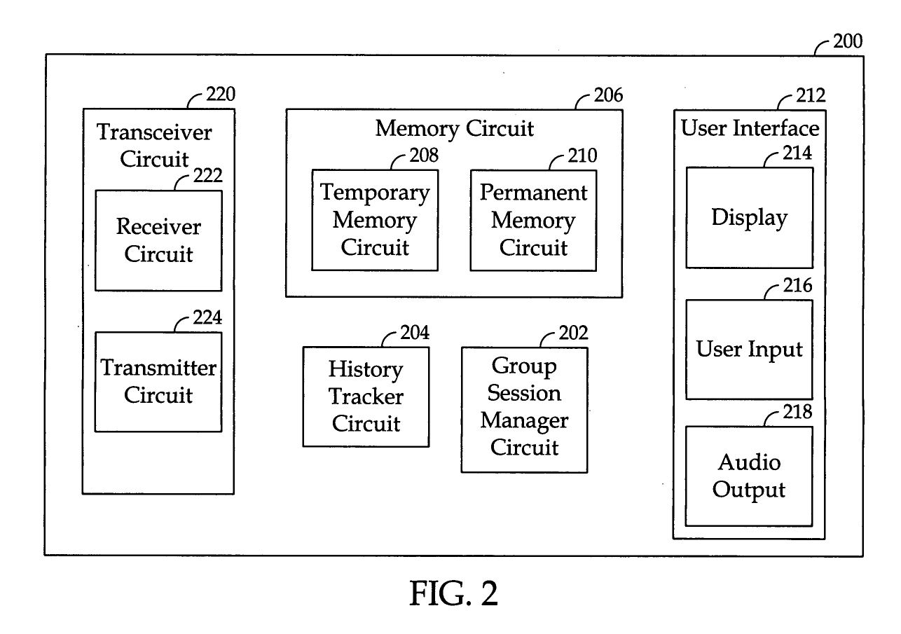

Referring to FIG. 2, a mobile station according to various embodiments of the invention is shown and indicated generally at 200. These various teachings contemplate either adapting the MSs 104, 106, 108, 110 and/or the server 102 to fully or partially implement the various embodiments described. As a result, the present transmitter circuit is given as one of many configurations and circuitry topologies available, and these various alternative embodiments, although not shown, are readily appreciated by one skilled in the art. Thus, they are within the scope of the various teachings described. The MS shown is a partial view of the circuit topology of a mobile device. As such, it should be understood that the various teachings may include other circuit components that are well known in the art that may not be shown. Moreover, “circuit” refers to one or more component devices such as, but is not limited to, processors, memory devices, application specific integrated circuits (ASICs), and/or firmware, which are created to implement or adapted to implement (perhaps through the use of software) certain functionality, all within the scope of the various teachings described.

In this exemplary MS 200 shown, a group session manager circuit 202 is included for obtaining, responsive to a group session being initiated, a group session history record associated with a group session having two or more users. A history tracker circuit 204, which is coupled to the group session manager circuit 202, then tracks history information of the group session that is saved to the group session history record in a memory circuit 206 having a temporary memory circuit 208 and a permanent memory circuit 210 for subsequent user usage.

Specifically, the group session manager circuit 202 is coupled to a user interface 212 that includes a display 214 that ultimately provides the history information to the users. The user can then use a user input 216 of the user interface 204 to select various items based on the history information for subsequent usage, such as initiating a new group based on the history information. An audio output 218 is also included as a part of the user interface 204 for audio communications for the group sessions. The group session manager circuit 202 is also adapted to provide a list of data files that were shared previously in group sessions.

According to various embodiments, the history information can either be saved locally on the mobile station and/or sent to the server. If the history information is saved and triggered internally at the mobile station, the memory circuit 206 is used for maintaining the history information along with their association with the group session or shared data file, which can be provided to users as a selectable list of items to initiate a new group session. If, on the other hand, the history information are maintained and saved at the server, the group session manager circuit 202 would then simply forward the tracked history information to the server via a transceiver circuit 220. As is typically done in any MS, a receiver circuit 222 for receiving data and a transmitter circuit 224 for transmitting data are included in the transceiver circuit 220 to effectuate, among other things, this communications exchange between the server 102 and the MS 200.

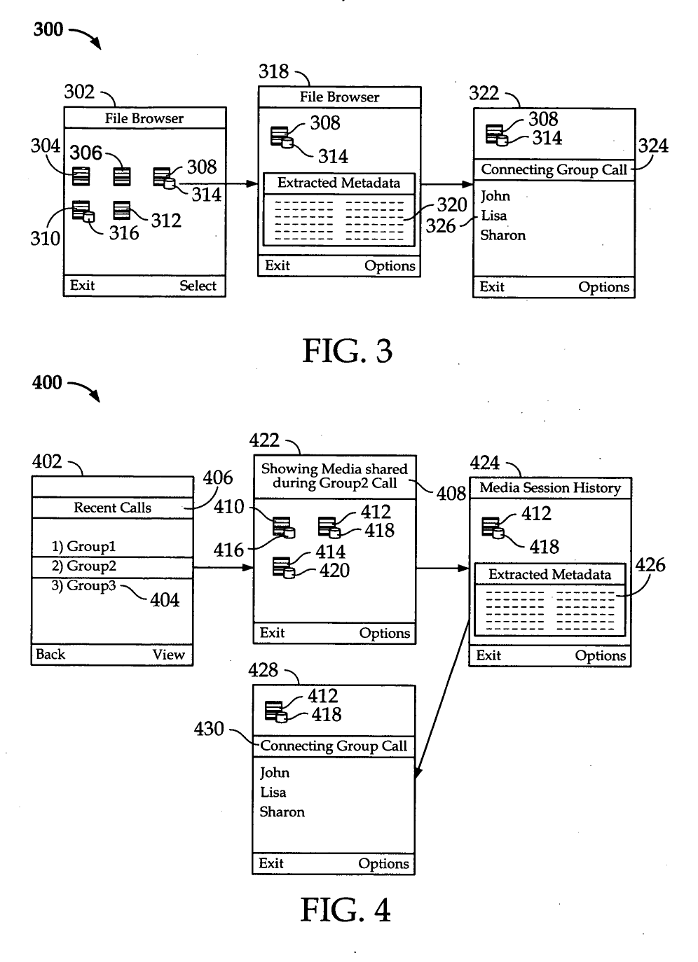

Turning now to FIG. 3, an exemplary user interface providing a list of file session history records according to one embodiment is shown and indicated generally at 300. As shown, a file browser 302 having a list of data files 304, 306, 308, 310, 312 is provided to the user selection. Some of the data files 308, 310 further optionally include an icon 314, 316 for indicating that the data file was shared during the group session, which will be referred to as shared data files 308, 310. As an example, if the user selects the shared data file 308 with the icon 314, another file browser 318 having extracted metadata 320 with the history information of the shared data file is provided to the user. There are multiple embodiments that are contemplated to link the history information with the group sessions and/or shared data files. For example, the file session history record is saved as a file or the file session history record can be embedded using for example, metadata, that is saved to the shared file data. Through the options provided in file browser 318, the user can, for example, open a window 322 for connecting a group call 324 using a group list 326 based on the extracted metadata 320 of the shared data file 308. Please note that the various embodiments contemplate any types of shared data file, such as audio, video, pictures, stream data, and the like.

Referring to FIG. 4, in contrast, an exemplary user interface providing a list of group session history records according to one embodiment is shown and indicated generally at 400. As shown, a recent calls window 402 shows a list of group sessions in a recent calls list 406. In this example shown, the user selects group 2, which has a list 408 of shared data files 410, 412, 414 having icons 416, 418, 420 shown in a second window 422. The user can also select the shared data file 412 from the list 408 to open a third window 424 with extracted metadata 426 of the shared data file 412. Using the extracted metadata 420, a forth window 428 is opened showing a group list 430 that shared the shared data file 412 during the group 2 session. From this, the user can initiate a new group session based on the history information associated with the shared data file 412.

Through various embodiments, multiple lists can be provided to a user, such as a list of the data files including shared data files and/or a list of previous group sessions. Moreover, the extracted metadata shown is one specific way to store the group session history record for storing history information associated with the group session and a file session history record, which stores history information associated with the shared data file from a previous group session. Of course, as will be readily apparent to one skilled in the art, multiple variations to provide and/or to maintain the history information of these group sessions are possible and they are within the scope of the various teachings described.

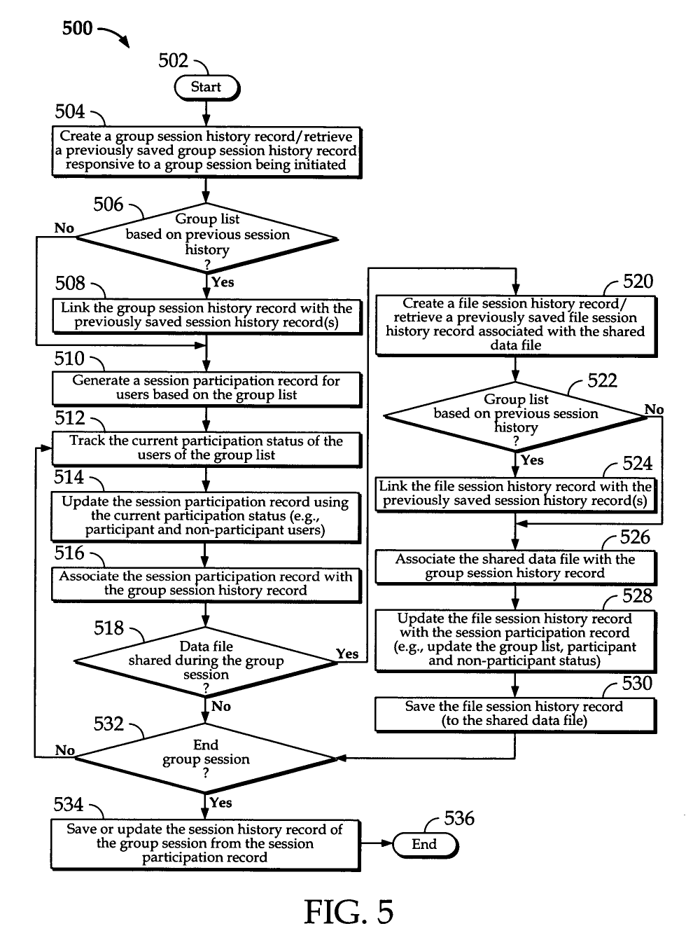

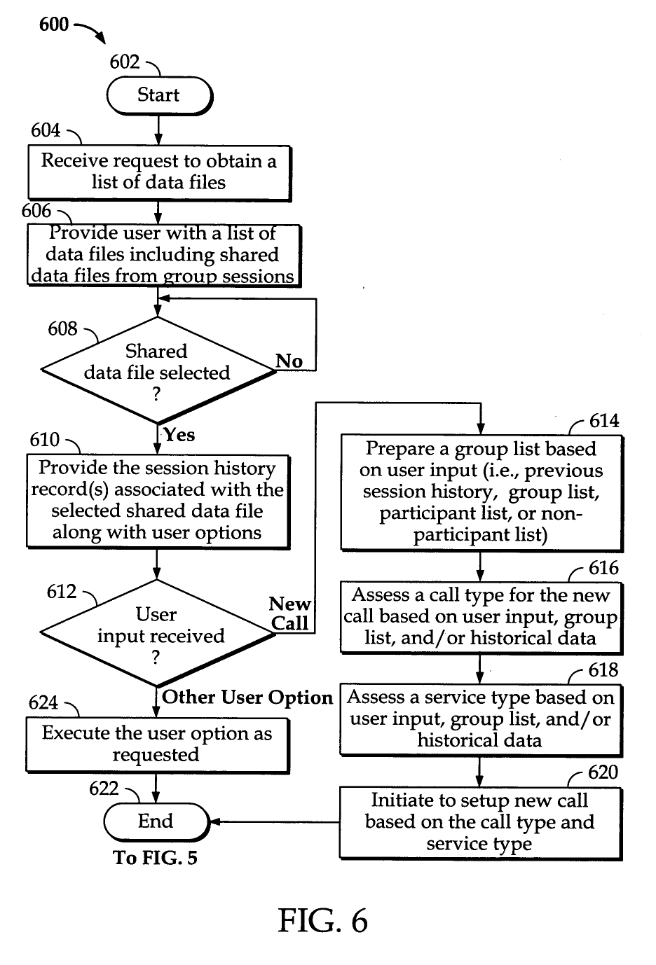

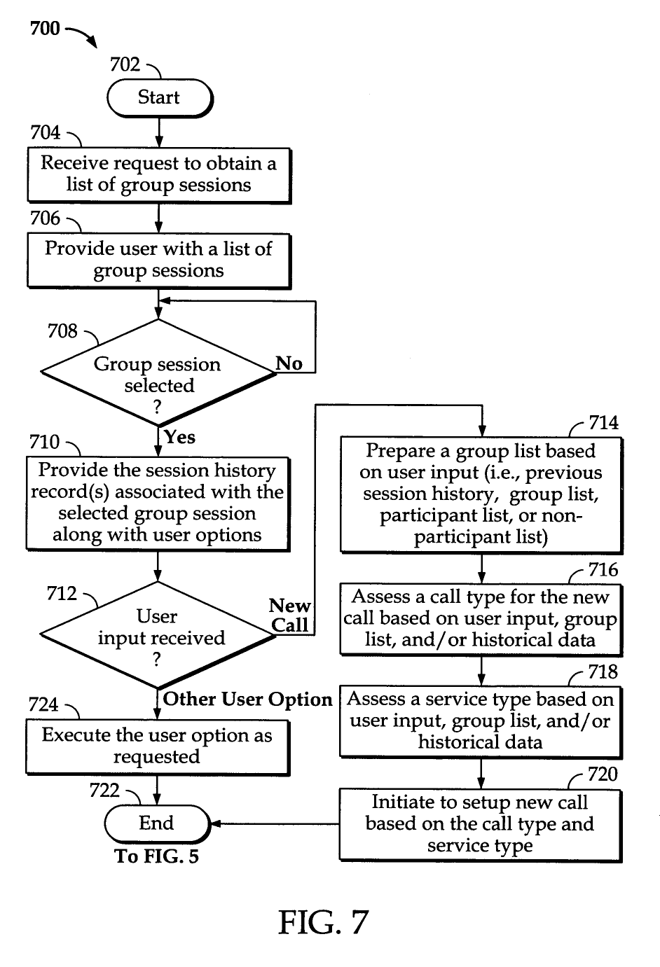

Turning to FIG. 5, a flow chart diagram of a tracking process triggered by a group session being initiated according to one embodiment is shown and indicated generally at 500. Although the process shown is preferably implemented at the mobile station 102, there may be other implementations of each of the processes shown that are better suited for the server in the communication system 100. These processes shown, thus, can be implemented fully or partially at any of the components within the system 100. Moreover, as one skilled in the art can readily appreciate, any of the processes shown can be altered in multiple ways to achieve the same functions and results of the various teachings described. As a result, these processes shown are one exemplary embodiment of multiple variation embodiments that may not be specifically shown. The processes shown are, thus, directed to the system 100, and each of them may be altered slightly to accommodate any of the components in the communications system. These other embodiments are within the scope of the various teachings described.

This particular tracking process 500 starts 502 by obtaining 504 a group session history record responsive to a group session being initiated. Specifically, a group session history record is created when the initiated group session is not based on a previously saved group session history record. In contrast, when the initiated group session is based on a previously saved group session history record, it is retrieved or a new record can be created for linking with the previously saved record. Since a group session requires two or more users to be involved in the call, a determination 506 is made as to whether a group list with the two or more users was based on a previous session history. If the group list is, in fact, based on a previous session history, the group session history record that was obtained 504 is linked 508 to one or more previously saved session history records associated with the previous session history. If, on the other hand, the group list is not based on a previous session history, the process continues without the need of such linkage.

The tracking process 500 continues and generates 510 a session participation record for the two or more users for this group list in order to track 512 current participation statuses of these users. In particular, if the user from the group list participated in the group session, the user will be given a participant user status. Alternatively, if the user does not participate in the group session, the user is given a nonparticipant user status. A group list includes the users that are invited to the group session, who may or may not participate in the group session. Of course, depending upon the configuration of the implementation, the participant and nonparticipant user statuses can be associated with the group session at different time periods or the shared data files. For example, a user that participated in the group session but did not share a data file can be given a participant user status associated to the group session while given a nonparticipant user status associated to the shared data file. As such, multiple ways to represent the participant status of the users are contemplated and they are within the scope of the various teachings.

Once the participant user statuses are tracked 512, they are updated 514 to the session participation record, which is associated 516 with the group session history record. At this juncture, a determination 518 is made as to whether a data file was shared during the group session, and if so, a file session history record is obtained 520 by either creating or retrieving it. It is next determined 522 whether a group list sharing the data file is based on a previous session history. If the group list sharing the data file is from a previous session history, the file session history record of the current group session is linked 524 with one or more previously saved file session history records of the previous session history. The process 500 continues either after the link 524 has been made or when the group list of the shared data file is not based on the previous session history.

An association 526 is made between the shared data file and the group session history record of the current session, which is updated with the session participation record of the users. The file session history record is saved, and specifically in one embodiment, it is saved as a file. In another embodiment, the file session history record can be embedded using for example, metadata, that is saved to the shared file data. Depending upon the specific design of the implementation, different ways to save the file session history record may be preferred. The tracking process 500 continues by determining 532 whether the group session should be terminated, and if not, it loops back from the tracking 512 of the current participation of the users. If, however, the group session should be terminated, the session history record of the group session should either be saved and/or updated 534 using the session participation record that was previously tracked. The tracking process 500 is completed at this point 536.

Turning now to FIG. 6, a flow chart diagram of a process to provide the file session history records requested by a user according to one embodiment is shown and indicated generally at 600. In this process 600, it starts 602 with a receipt 604 of a request to obtain a list of data files including shared data files during group sessions. The user is then provided 606 with the list of the data files, followed by a determination 608 of whether a shared data file has been in fact selected by the user. If not, the process 600 loops back until the user selects a shared data file. At this point, the process 600 accordingly provides 610 the session history records, which includes both the file session history records and group session history records, associated with the selected shared data file along with user options, followed by a determination 612 as to whether the user input has been received.

For a new call input from the user, a group list is prepared 614 based on a user input, such as a selected previous session history, a new group list, a previous group list, a participant list, and/or a non-participant list. A call type and/or service type is then assessed 616, 618 based on the user input, group list, or historical data to initiate 620 and set up a new call (e.g., group session) based on the call type and service type. The process ends 622 at this point. If, however, another user option, such as delete, edit, or select, is provided by the user, the process 600 accordingly executes 624 the user option as requested, which also ends 622 the process at this point.

Turning now to FIG. 7, a flow chart diagram of a process to provide the group session history records requested by a user according to one embodiment is shown and indicated generally at 700. The process 700 starts 702 with a receipt 704 of a request to obtain a list of group sessions, which is accordingly provided 706 to the user. It is next determined 708 whether a group session has been selected by the user. If not, the process 700 keeps checking until a group session has been selected. Once this is the case, session history records associated with the selected group session is provided 710 to the user along with user options, followed by a determination 712 as to whether such a user input has been received. If the user input is to make a new call, a group list based on user input, such as previous session history, group list (both new and previously saved), participant list, or nonparticipant list, is prepared 714. A call type and service type is then assessed 716, 718 based on the user input, group list, and/or historical data for initiating 720 to setup a new call, and the process ends 722 at this point. For when the user input is another user option, such as select, delete, edit, or like, the user option is executed 724 as requested, which brings the process 700 to an end 722.

Through these various teachings, a mechanism is provided that, among other things, tracks history information of a group session that can be subsequently provided responsive to a user request. Specifically, the various teachings enable users to establish a new group session based on session history information associated with previous group sessions, which may include a group list based on the user participation status, call type, and/or service type. Moreover, according to various embodiments, a new group session can also be initiated based on a shared data file shared during a previous group session. Since history information of a group session is being tracked, users are able to refer to this saved tracked history information to initiate other new group sessions. Thus, a more flexible and desired user functionality has been added to the communications system.

Those skilled in the art will recognize that a wide variety of modifications, alterations, and combinations can be made with respect to the above described embodiments without departing from the broad scope of the invention, and that such modifications, alterations, and combinations are to be viewed as being within the ambit of the inventive concept.

We claim:

1. A method for tracking history information of a group session comprising the steps of:
obtaining a group session history record associated with a group session having at least two users responsive to the group session being initiated;
tracking history information of the group session to provide tracked history information;
saving the tracked history information to the group session history record;
saving the group session history record to subsequently provide the tracked history information responsive to a user request.

2. The method according to claim 1, wherein obtaining a group session history record further comprises the steps of:
creating the group session history record when the group session is not based on a previous group session;
retrieving a previously saved group session history record when the group session is based on a previous group session.

3. The method according to claim 1, wherein tracking history information of the group session further comprises the step of:
linking the group session history record with at least one previously saved group session history record when at least one of the two users is invited based on the at least one previously saved group session history.

4. The method according to claim 1, wherein tracking history information of the group session further comprises the steps of:
generating a session participation record for the at least two users;
tracking current participation status of the at least two users;
updating the session participation record using the current participation status;
associating the session participation record with the group session history record.

5. The method according to claim 4, wherein the current participation status comprises any one or more selected from a group of participant user status indicating participation of the group session and nonparticipant user status indicating nonparticipation of the group session.

6. The method according to claim 1, wherein tracking history information of the group session further comprises the steps of:
obtaining a file session history record associated with at least one shared data file shared during the group session;
updating the file session history record with the tracked history information of the group session history record;
saving the file session history record to subsequently provide the tracked history information responsive to a user request.

7. The method according to claim 6, wherein obtaining a file session history record further comprises the steps of:
creating the file session history record when the shared data file has not been previously shared during a group session;
retrieving a previously saved file session history record when the shared data file has been previously shared during a group session.

8. The method according to claim 6, wherein tracking history information of the group session further comprises the step of:
linking the file session history record with at least one previously saved file session history record when at least one of the two users is invited based on the at least one previously saved file session history record.

9. The method according to claim 1, wherein tracking history information of the group session to provide tracked history information further comprises the step of:
associating a shared data file with the group session history record.

10. A method for tracking history information of a group session comprising the steps of:
providing a list of items based, at least in part, on history information related to group sessions responsive to a user request to obtain the list of items;
providing at least one previously saved session history record associated with at least one selected item.

11. The method according to claim 10, wherein the at least one previously saved session history record comprises any one or more selected from a group of a previously saved group session history record and a previously saved file session history record.

12. The method according to claim 10 further comprising the step of:
preparing, responsive to a user input to call a group session, a group list having at least one user based, at least in part, on the previously saved session history record associated with the selected item.

13. The method according to claim 12 further comprising the step of:
assessing a call type for the group session based, at least in part, on one or more selected from a group of user input, the group list, and previously saved session history record associated with the selected item.

14. The method according to claim 12 further comprising the step of:
assessing a service type for the group session based, at least in part, on one or more selected from a group of user input, the group list, and previously saved session history record associated with the selected item.

15. The method according to claim 12 further comprising the step of:
initiating setup of the group session using, at least in part, the group list.

16. The method according to claim 12 further comprising the steps of:
assessing a call type for the group session based, at least in part, on one or more selected from a group of user input, the group list, and previously saved session history record associated with the selected item;
assessing a service type for the group session based, at least in part, on one or more selected from a group of user input, the group list, and previously saved session history record associated with the selected item;
initiating setup of the group session based on the call type and the service type.

17. The method according to claim 10, wherein the list of items comprises any one or more selected from a group of group sessions, data files comprises shared data files during at least one group session, and shared data files from at least one of the group sessions.

18. The method according to claim 10 further comprising the step of:
initiating setup of a group session based, at least in part, on any one or more selected from a group at least one group session history record and at least one file session history record.

19. An apparatus for tracking history information of a group session, the apparatus comprising:
a group session manager circuit that obtains, responsive to a group session being initiated, a group session history record associated with a group session having at least two users;
a history tracker circuit coupled to the group session manager circuit, wherein the history tracker circuit tracks history information of the group session to provide tracked history information saved to the group session history record;
a memory circuit coupled to the group session manager circuit and the history tracker circuit, wherein the memory circuit stores the group session history record for subsequent user usage.

20. The apparatus according to claim 19 further comprising:
a user interface coupled to the group session manager and the memory circuit, wherein the user interface provides a list of items based, at least in part, on history information related to group sessions responsive to a user request to obtain the list of items and at least one previously saved session history record associated with a selected item.
